(19) United States
(12) Patent Application Publication
(10) Pub. No.: US 2016/0236293 A1
(43) Pub. Date: Aug. 18, 2016

(54) APPARATUS FOR METAL ADDITIVE MANUFACTURING AND ELECTRICAL DISCHARGE MACHINING

(71) Applicant: EXCETEK TECHNOLOGIES CO., LTD., Taichung City (TW)

(72) Inventors: Jui-Chen CHANG, Taichung City (TW); Song-Neng CHENG, Taichung City (TW); Shuo-Chen JIAN, Taichung City (TW); Yu-Ling CHANG, Taichung City (TW)

(21) Appl. No.: 15/012,104

(22) Filed: Feb. 1, 2016

(30) Foreign Application Priority Data
Feb. 16, 2015 (TW) 104105387

(51) Int. Cl. B23H 7/38; B23H 7/34; B23H 7/36; B23K 26/144; B23K 26/342; B23K 26/70; B23K 26/08; B23H 7/32; B23H 5/00

(52) U.S. Cl. CPC B23H 7/38; B23H 7/32; B23H 7/34; B23H 7/36; B23H 5/00; B23K 26/342; B23K 26/70; B23K 26/0861; B23K 26/0876; B23K 26/144; B33Y 30/00

(57) ABSTRACT

An apparatus for metal additive manufacturing and electrical discharging is used to machine a metal powder into a rigid body, and includes an apparatus frame unit, an additive manufacturing unit, and an electrical discharge machining unit. The additive manufacturing unit includes a powder applying unit for applying a layer of the metal powder onto a processing lift table of the apparatus frame unit, and a laser unit for heating a part of the metal powder within an imaginary contour line to form the rigid body. The electrical discharge machining unit includes a powder removing member for removing a part of the metal powder proximate to the imaginary contour line, and an electrode member for machining the rigid body via electrical discharge.

### CROSS-REFERENCE TO RELATED APPLICATION

This application claims priority of Taiwanese Patent Application No. 104105387, filed on Feb. 16, 2015.

### FIELD

The disclosure relates to an apparatus for metal additive manufacturing and electrical discharge machining.

### BACKGROUND

U.S. Pat. No. 6,657,155 B2 discloses a method of and an apparatus for making a three-dimensional object. To make the three-dimensional object, an optical beam is first irradiated on a metal powder layer to form a sintered layer. Then, a cutting machine is used to directly contact and physically machine the sintered layer to obtain a desired shape. However, metal swarf produced when performing physical machining has a dimension larger than that of the metal powder layer, and may cause the sintered layer to have voids. The metal swarf may also result in formation of burr at an edge of the three-dimensional object. Moreover, the metal swarf may be oxidized by the heat generated during machining, and needs to be sieved and discarded, resulting in increased manufacturing costs.

### SUMMARY

Therefore, an object of the present disclosure is to provide an apparatus that can alleviate at least one of the drawbacks associated with the prior art.

According to the present disclosure, an apparatus is for metal additive manufacturing and electrical discharging, and is used to machine a metal powder into a rigid body.

The apparatus includes an apparatus frame unit, an additive manufacturing unit, and an electrical discharge machining unit.

The apparatus frame unit includes a main frame and a processing lift table. The main frame has a processing surface and a processing space that is recessed from the processing surface. The processing lift table is received in the processing space, and is movable relative to the processing surface in a vertical direction that is perpendicular to the processing surface.

The additive manufacturing unit is disposed on the main frame, and includes a powder applying unit and a laser unit. The powder applying unit includes a powder applying member that is used to apply a layer of the metal powder onto the processing lift table, so that the metal powder is flush with the processing surface of the main frame. The laser unit is disposed on the main frame and is used to heat a part of the metal powder that is disposed within an imaginary contour line to form the rigid body having a contour that is defined by the imaginary contour line.

The electrical discharge machining unit is disposed on the main frame, is proximate to the additive manufacturing unit, and includes a carrier unit, a powder removing member, and an electrode member. The carrier unit removably holds the electrode member and is movable relative to the main frame. The powder removing member is disposed on the carrier unit. The powder removing member is used to remove a part of the metal powder that is proximate to the imaginary contour line. The electrode member is used to machine the rigid body via electrical discharge.

### BRIEF DESCRIPTION OF THE DRAWINGS

Other features and advantages of the present disclosure will become apparent in the following detailed description of the embodiment with reference to the accompanying drawings, of which:

FIG. 1 is a schematic view showing an embodiment of an apparatus for metal additive manufacturing and electrical discharge machining according to the present disclosure;

FIG. 2 is a schematic view showing a rigid body manufactured by the embodiment, formed from a metal powder, and defined by an imaginary contour line; and

FIGS. 3 to 7 illustrate consecutive steps of operating the embodiment.

### DETAILED DESCRIPTION

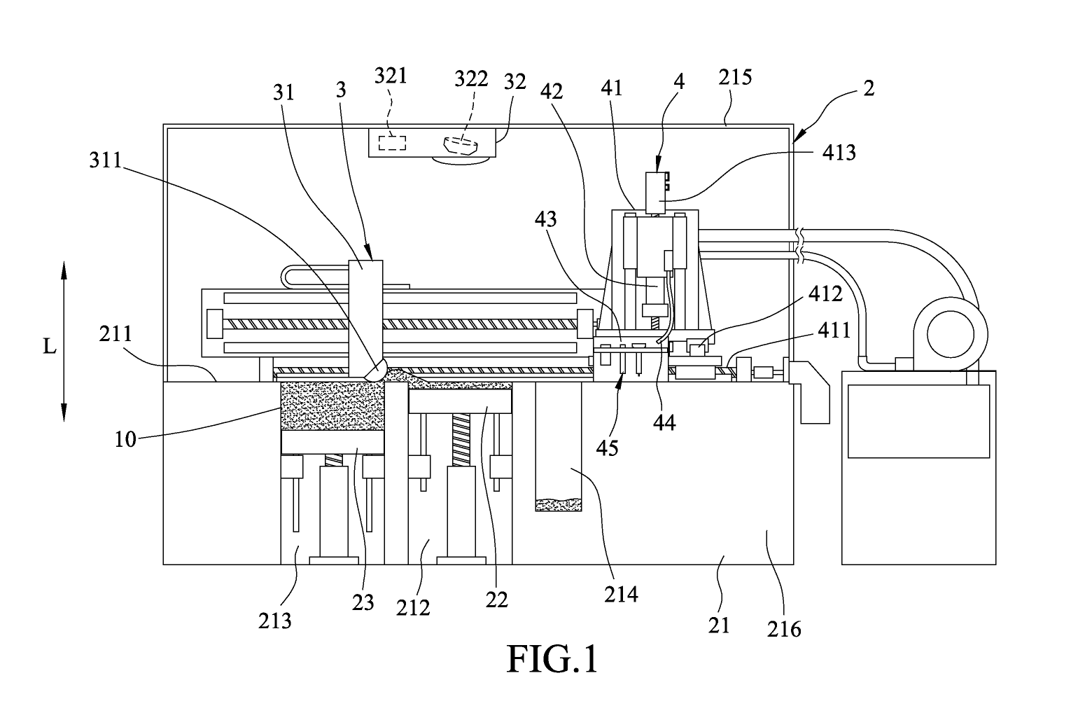

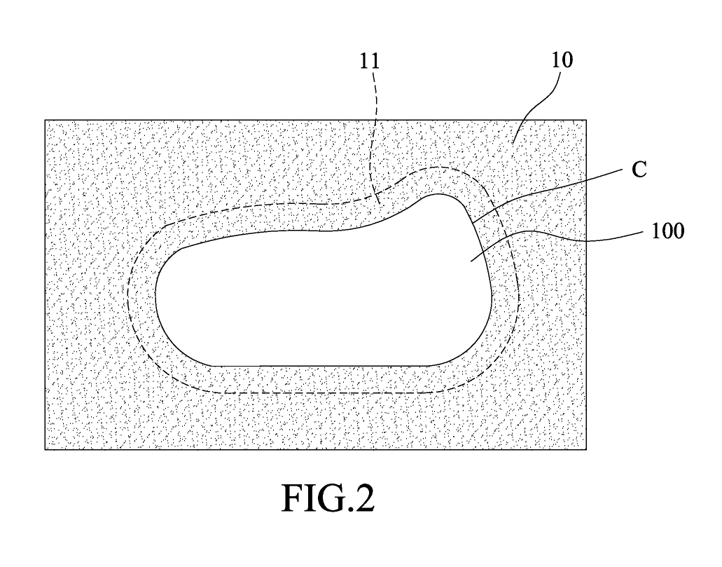

Referring to FIGS. 1 and 2, an embodiment of an apparatus of the present disclosure is for metal additive manufacturing and electrical discharge machining. The apparatus is used to machine a metal powder 10 into a rigid body 100, and includes an apparatus frame unit 2, an additive manufacturing unit 3, and an electrical discharge machining unit 4.

The apparatus frame unit 2 includes a main frame 21, a processing lift table 22, and a powder supply lift table 23.

The main frame 21 has a processing surface 211, a processing space 212, a powder supply space 213, and a powder recovery space 214. The processing space 212 is recessed from the processing surface 211. The powder supply space 213 and the powder recovery space 214 are respectively disposed at two opposite sides of the processing space 212, and are recessed from the processing surface 211. In this embodiment, the main frame 21 is an assembly of an upper frame body 215 and a lower frame body 216. The processing surface 211, the processing space 212, the powder supply space 213, and the powder recovery space 214 are located at the lower frame body 216.

The processing lift table 22 is received in the processing space 212, and is movable relative to the processing surface 211 in a vertical direction (L) that is perpendicular to the processing surface 211. In this embodiment, the processing lift table 22 is connected to a ball screw so as to be movable along a linear track. The movement of the ball screw together with the processing lift table 22 is precisely controlled by a servo motor. The moving mechanism of the processing lift table 22 may alternatively be a linear motor cooperating with an optical scale, a servo motor cooperating with an assembly of rack and pinion, a belt drive assembly, etc., and should not be limited to what are disclosed herein.

The powder supply lift table 23 is received in the powder supply space 213 of the main frame 21 for moving the metal powder 10 relative to the processing surface 211. The moving mechanism of the powder supply lift table 23 is similar to that of the processing lift table 22, and is therefore not further described for the sake of brevity.

The additive manufacturing unit 3 is disposed on the main frame 21, and includes a powder applying unit 31 and a laser unit 32.

The powder applying unit 31 includes a powder applying member 311 that is used to apply a layer of the metal powder 10 onto the processing lift table 22, so that the metal powder 10 is flush with the processing surface 211 of the main frame 21.

The laser unit 32 is disposed on the main frame 21 and is used to heat a part of the metal powder 10 that is disposed within an imaginary contour line (C) to form the rigid body 100 having a contour that is defined by the imaginary contour line (C). The laser unit 32 includes a laser emitting member 321 and a reflection member 322. The laser emitting member 321 is capable of emitting a laser beam, and the reflection member 322 is capable of guiding the laser beam toward the metal powder 10 that is disposed on the processing lift table 22.

Specifically, the processing lift table 22 is movable downwards relative to the processing surface 211 by a desired distance, so as to allow the powder applying member 311 to apply the metal powder 10 onto the processing lift table 22. Then the laser unit 32 starts to focus the laser beam into the part of the metal powder 10 and begins to heat the part of the metal powder 10. With said configuration, the rigid body 100 can be formed to have a precisely defined contour and shape. In this embodiment, the distance by which the processing lift table 22 moves downwards ranges from 0.01 mm to 0.50 mm. In certain embodiment, the distance is fixed at 0.05 mm.

The electrical discharge machining unit 4 is disposed on the main frame 21, is proximate to the additive manufacturing unit 3, and includes a carrier unit 41, a holder 42, a holding seat 43, at least one powder removing member 44, and at least one electrode member 45. In this embodiment, the electrical discharge machining unit 4 is disposed immediately proximate to the additive manufacturing unit 3.

The carrier unit 41 removably holds the electrode member 45, is movable relative to the main frame 21, and includes a long axis carrier 411, a short axis carrier 412, and a lift carrier 413. The long axis carrier 411 is disposed on the main frame 21 and is movable in a long axis direction that is parallel to the processing surface 211. The short axis carrier 412 is disposed on the long axis carrier 411 and is movable in a short axis direction that is perpendicular to the long axis direction and parallel to the processing surface 211. The lift carrier 413 is disposed on the short axis carrier 412 and is movable in the vertical direction (L). The moving mechanisms for moving the long axis carrier 411, the short axis carrier 412, and the lift carrier 413 are similar to that of the processing lift table 22 as disclosed hereinabove, and is therefore not further described for the sake of brevity.

The holder 42 is disposed on the lift carrier 413 for removably holding the electrode member 45.

The powder removing member 44 is disposed on the carrier unit 41. In this embodiment, the powder removing member 44 and the holder 42 are disposed on the lift carrier 413 and spaced apart from each other. The holding seat 43 is disposed on the main frame 21. The electrode member 45 is removably disposed on the holding seat 43. The powder removing member 44 is used to remove a part of the metal powder 10 that is proximate to the imaginary contour line (C).

The electrode member 45 is used to machine the rigid body 100 via electrical discharge.

In operation, the holder 42 can be positioned above the holding seat 43, through the movement of the long axis carrier 411, the short axis carrier 412, and the lift carrier 413, for removably holding the electrode member 45. When the electrode member 45 is removably disposed on the lift carrier 413, it is movable relative to the main frame 21 in a selected one of the long axis direction, the short axis direction, and the vertical direction (L).

In this embodiment, an external device (e.g., a pump) can provide a negative pressure so that the powder removing member 44 is capable of removing the part of the metal powder 10 proximate to the imaginary contour line (C), thereby avoiding the part of metal powder 10 proximate to the imaginary contour line (C) to be melted and attached to the rigid body 100 during subsequent electrical discharge processing. In this embodiment, the electrode member 45 machines at least a part of the rigid body 100 defined by the imaginary contour line (C). The powder removing member 44 removes an endless elongated part 11 of the metal powder 10. The endless elongated part 11 has an inner periphery surrounding and adjoining the imaginary contour line (C), and a width not less than 1 mm. In certain embodiments, the endless elongated part 11 has a width ranging from 5 mm to 10 mm.

In certain embodiments, the electrode member 45 is in a form of a hollow tube (not shown), and the powder removing member 44 is configured as a center bore formed in the hollow tube and permits air to pass therethrough in two opposite directions to remove the endless elongated part 11 of the metal powder 10 that is proximate to the imaginary contour line (C) by one of a blowing force and a suction force. In certain embodiments, the powder removing member 44 removes the endless elongated part 11 of the metal powder 10 that is proximate to the imaginary contour line (C) by one of a blowing force, a suction force, and a scratch force. In certain embodiments, the metal powder 10 is ferromagnetic, and the powder removing member 44 removes the part of the metal powder 10 that is proximate to the imaginary contour line (C) by a magnetic attractive force. The method for removing the metal powder 10 that is proximate to the imaginary contour line (C) via the powder removing member 44 should not be limited to what are disclosed herein, and may be changed according to practical requirements. It is worth mentioning that the metal powder 10 removed by the powder removing member 44 is not sintered or oxidized by the laser unit 32, and therefore may be recycled, thereby reducing manufacturing costs.

In this embodiment, the number of the powder removing member 44 is one, and the number of the electrode member 45 is three. Therefore, one of the electrode member 45 that has a suitable shape may be selected for different requirements. For example, when machining the contour of the rigid body 100 that is defined by the imaginary contour line (C), the electrode member 45 with a small diameter (e.g., a needle-shaped electrode member) may be used. When machining a surface of the rigid body 100, the electrode member 45 with a large diameter (e.g., a linear-shaped electrode member) may be used.

Referring to FIGS. 1 and 3 to 7, a method of operating the apparatus for metal additive manufacturing and electrical discharge machining to manufacture the rigid body 100 is disclosed in the following steps.

In a first step, an operator pours the metal powder 10 into the powder supply space 213, so that a layer of the metal powder 10 is disposed on the powder supply lift table 23.

In a second step, the processing lift table 22 moves downwards relative to the processing surface 211 by the desired distance. In this embodiment, the desired distance may range from 0.01 mm to 0.50 mm or alternatively be fixed at 0.05 mm.

In a third step, as shown in the FIG. 1, the powder supply lift table 23 moves upwards relative to the processing surface 211 to raise the metal powder 10 to a position higher than the processing surface 211, followed by applying the metal powder 10 onto the processing lift table 22 so that the metal powder 10 is flush with the processing surface 211. The remaining metal powder 10 is subsequently collected in the powder recovery space 214.

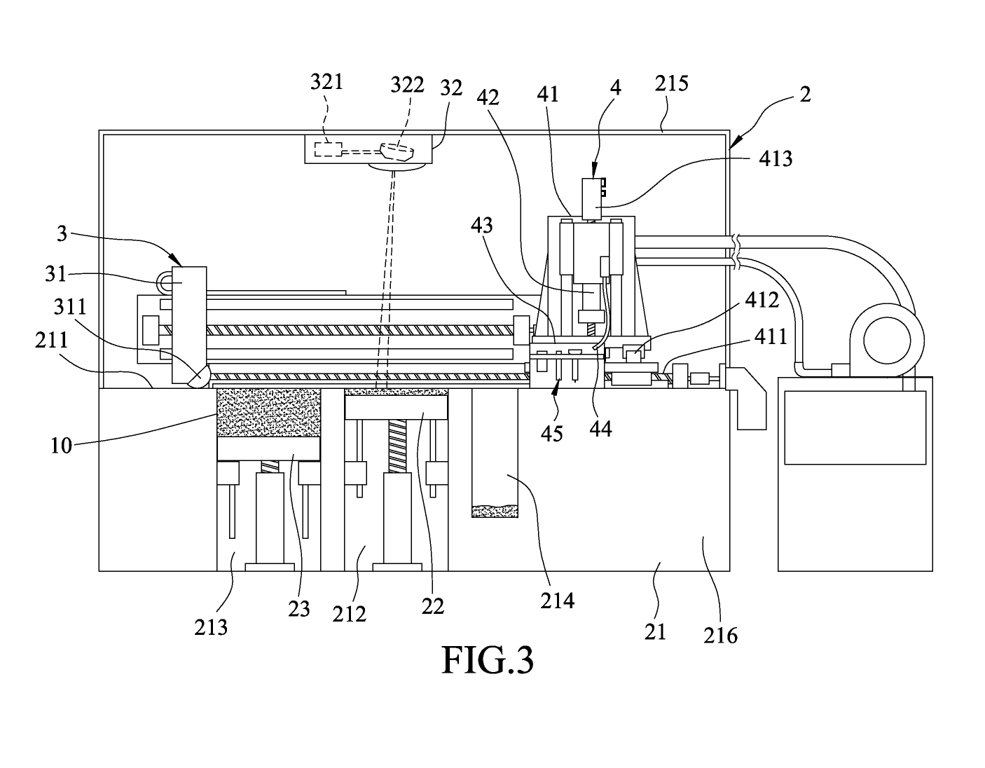

In a fourth step, as shown in FIG. 3, the laser emitting member 321 of the laser unit 32 emits the laser beam, and the reflection member 322 guides the laser beam toward the metal powder 10 to heat the part of metal powder 10 disposed within an imaginary contour line (C), so as to form the rigid body 100.

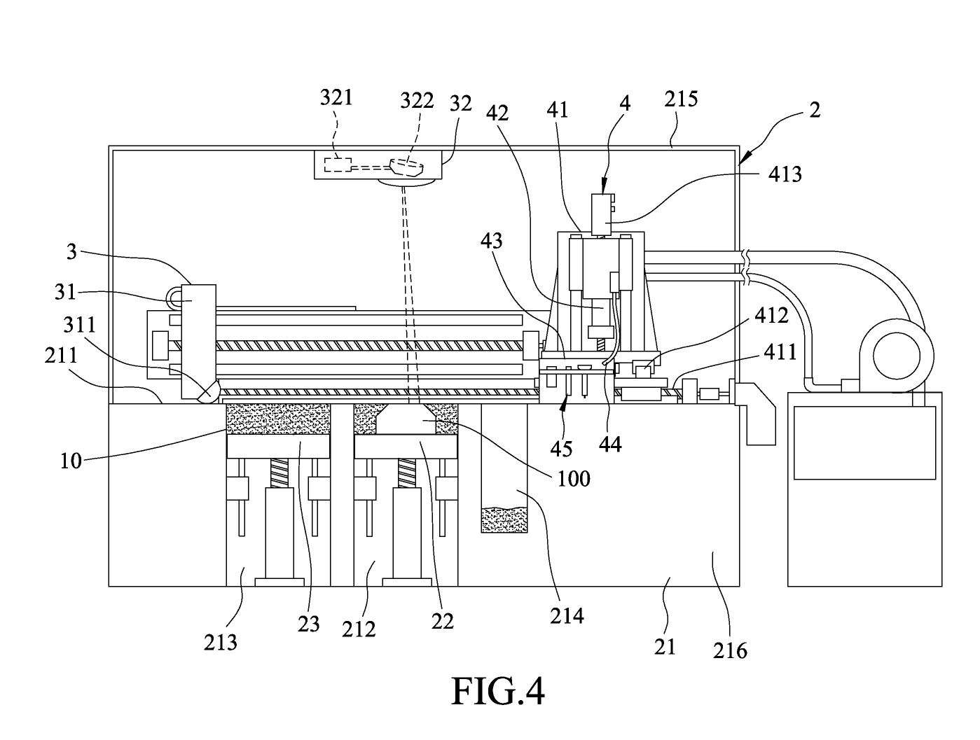

In a fifth step, as shown in FIG. 4, the first to fourth steps may be repeated for five times to form the rigid body 100 with desired shape. It should be noted that the number of repetition times is not limited to five and may be changed according to practical requirements.

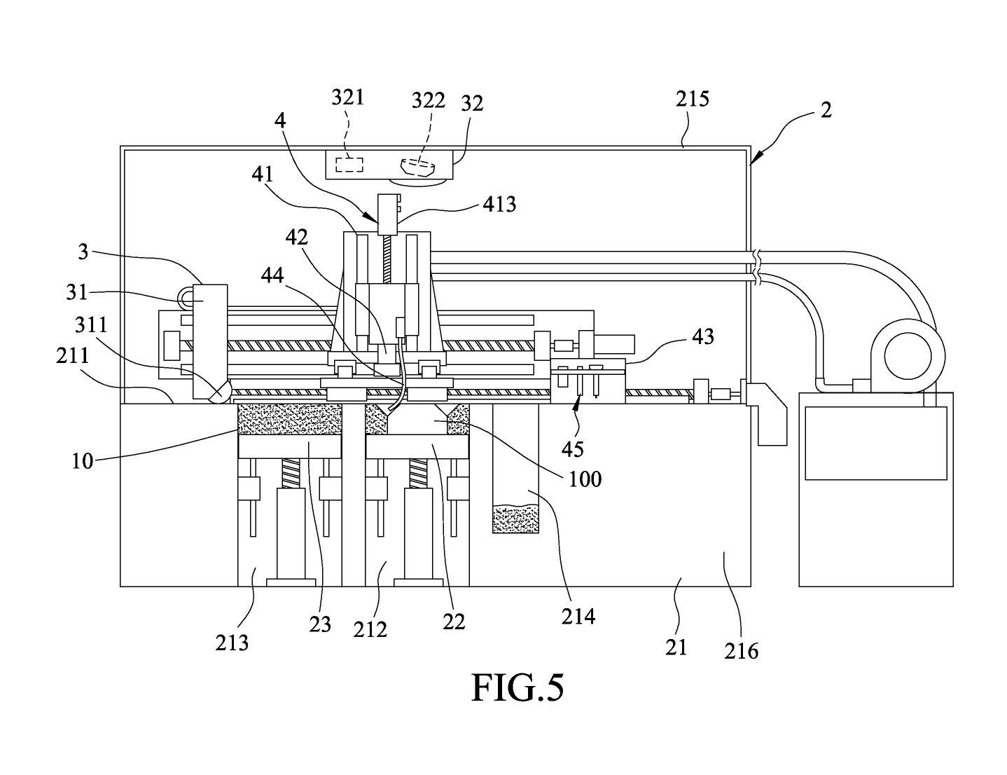

In a sixth step, as shown in FIG. 5, the powder removing member 44 removes the endless elongated part 11 of the metal powder 10 by the distance of at least 1 mm, alternatively by the distance ranging from 5 mm to 10 mm.

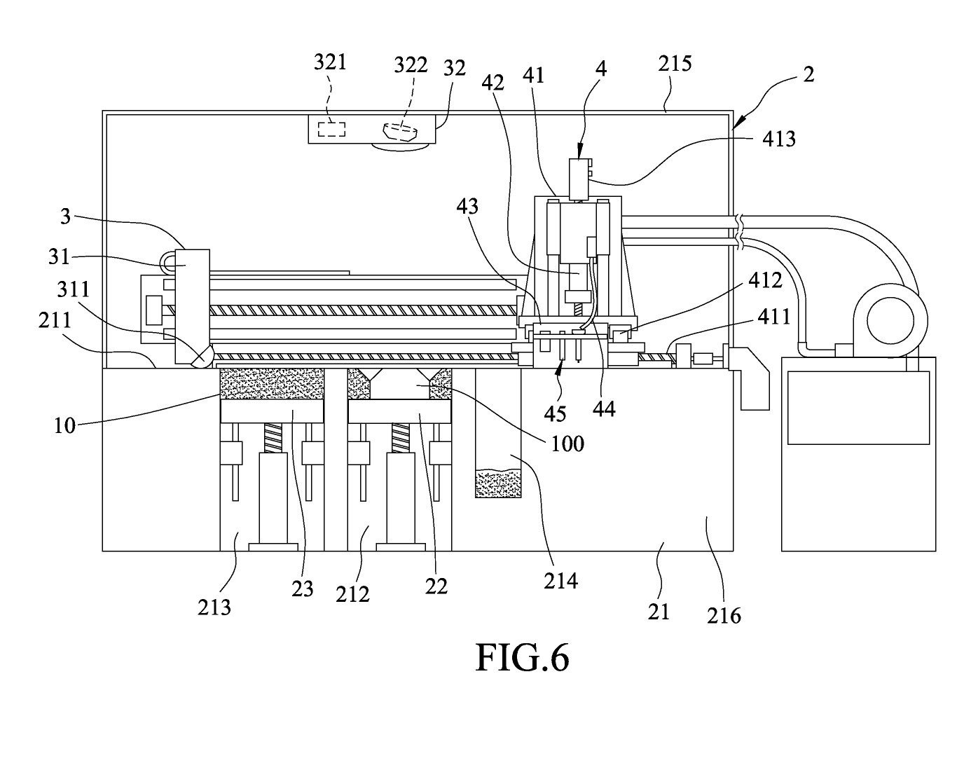

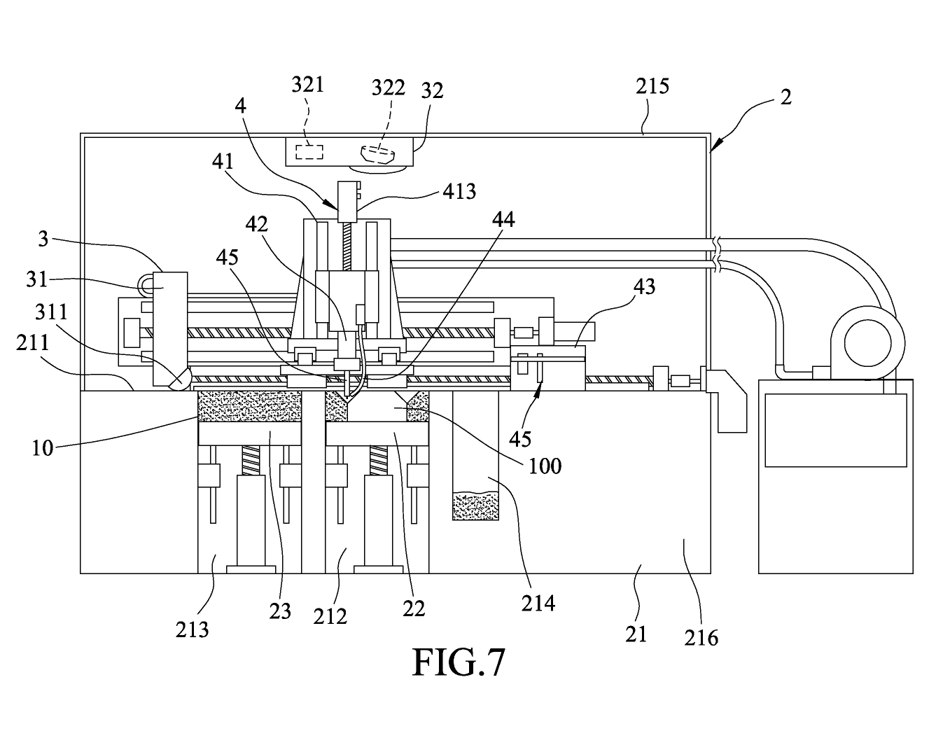

In an seventh step, as shown in FIGS. 6 and 7, the holder 42 moves with the carrier unit 41 to a position above the holding seat 43, and the electrode member 45 is held by the holder 42. Then, the electrode member 45 machines a surface or along the imaginary contour line (C) of the rigid body 100, so that the rigid body 100 can have desired dimensional precision.

In a eighth step, the first to seventh steps may be repeated to obtain the rigid body 100 with desired dimension, and then the processing lift table 22 lifts up so that the rigid body 100 can be easily removed from the apparatus.

The merits of the apparatus for metal additive manufacturing and electrical discharge machining are summarized below.

The electrical discharge machining unit 4 provides better dimensional precision to the rigid body 100. Moreover, the electrode member 45 of the electrical discharge machining unit 4 provides heat that can evaporate metal burr of the rigid body 100.

The powder removing member 44 is capable of removing the part of the metal powder 10 proximate to the imaginary contour line (C), thereby avoiding the part of metal powder 10 proximate to the imaginary contour line (C) to be melted and attached to the rigid body 100 during subsequent electrical discharge processing. Moreover, the metal powder 10 removed by the powder removing member 44 can be recycled for reuse, thereby reducing manufacturing costs.

With the carrier unit 41, movement action of the processing lift table 22 can be minimized, thereby minimizing jumping out of the metal powder 10 during movement of the processing lift table 22.

The holding seat 43 is provided for the electrode member 45 to be disposed thereon, and the holder 42 can hold the electrode member 45, thereby providing flexibility in manufacturing process.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An apparatus for metal additive manufacturing and electrical discharge machining, and being adapted to machine a metal powder into a rigid body, said apparatus comprising:
an apparatus frame unit including a main frame and a processing lift table, said main frame having a processing surface and a processing space that is recessed from said processing surface, said processing lift table being received in said processing space, and being movable relative to said processing surface in a vertical direction that is perpendicular to said processing surface;
an additive manufacturing unit disposed on said main frame, and including a powder applying unit and a laser unit, said powder applying unit including a powder applying member that is adapted to apply a layer of the metal powder onto said processing lift table, so that the metal powder is flush with said processing surface of said main frame, said laser unit being disposed on said main frame and being adapted to heat a part of the metal powder that is disposed within an imaginary contour line to form the rigid body having a contour that is defined by the imaginary contour line; and
an electrical discharge machining unit disposed on said main frame, proximate to said additive manufacturing unit, and including a carrier unit, a powder removing member, and an electrode member, said carrier unit removably holding said electrode member and being movable relative to said main frame, said powder removing member being disposed on said carrier unit and being adapted to remove a part of the metal powder that is proximate to the imaginary contour line, said electrode member being adapted to machine the rigid body via electrical discharge.

2. The apparatus as claimed in claim 1, wherein said carrier unit includes a long axis carrier, a short axis carrier, and a lift carrier, said long axis carrier being disposed on said main frame and being movable in a long axis direction that is parallel to said processing surface, said short axis carrier being disposed on said long axis carrier and being movable in a short axis direction that is perpendicular to the long axis direction and parallel to said processing surface, said lift carrier being disposed on said short axis carrier and being movable in the vertical direction, said electrode member being removably disposed on said lift carrier such that said electrode member is movable relative to said main frame in a selected one of the long axis direction, the short axis direction, and the vertical direction.

3. The apparatus as claimed in claim 2, wherein said electrical discharge machining unit further includes a holder disposed on said lift carrier for removably holding said electrode member.

4. The apparatus as claimed in claim 3, wherein said electrical discharge machining unit further includes a holding seat disposed on said main frame, said electrode member being removably disposed on said holding seat.

5. The apparatus as claimed in claim 3, wherein said powder removing member and said holder are disposed on said lift carrier and spaced apart from each other.

6. The apparatus as claimed in claim 1, wherein said powder removing member removes the part of the metal powder that is proximate to the imaginary contour line by one of a blowing force, a suction force, and a scratch force.

7. The apparatus as claimed in claim 1, wherein the metal powder is ferromagnetic, and said powder removing member removes the part of the metal powder that is proximate to the imaginary contour line by a magnetic attractive force.

8. The apparatus as claimed in claim 1, wherein said main frame further has a powder supply space and a powder recovery space that are respectively disposed at two opposite sides of said processing space, and that are recessed from said processing surface.

9. The apparatus as claimed in claim 1, wherein said electrode member machines at least a part of the rigid body defined by the imaginary contour line, and said powder removing member removes an endless elongated part of the metal powder, said endless elongated part of said metal powder having an inner periphery surrounding and adjoining the imaginary contour line, and having a width not less than 1 mm.
